(19) United States
(12) Patent Application Publication
(10) Pub. No.: US 2020/0312186 A1
(43) Pub. Date: Oct. 1, 2020

(54) LEARNING MATH USING MATH TEMPLATES AND OPERATION-NUMBER CONJUGATES

(71) Applicant: Ronen BEN NUN, Herzelia (IL)

(72) Inventor: Ronen BEN NUN, Herzelia (IL)

(21) Appl. No.: 16/371,002

(22) Filed: Mar. 31, 2019

(51) Int. Cl. G09B 19/02; G09B 19/22

(52) U.S. Cl. CPC G09B 19/02; G09B 19/22

(57) ABSTRACT

An apparatus and method for learning math includes a template of one or more mathematical exercises that are solved using conjugates of mathematical operations and numbers. Each exercise includes two or more math expressions, one or more math relationships, and one or more blanks. A plurality of action tokens are provided including a plurality of operator-number tokens displaying a conjugate of a mathematical operation and a number. A given number of action tokens are provided to one or more players to provide each of the players with a hand of action tokens. Turns are taken by each of the players, to try to solve said template by playing from the player's hand at least one operator-number token to fill-in at least one blank, thereby creating a correct mathematical sentence based on the template. The goal is to complete correctly the exercises.

### FIELD OF THE INVENTION

The present invention generally relates to learning, and in particular, it concerns a structured template and tokens for learning math.

### BACKGROUND OF THE INVENTION

Structured learning devices can be used for educational, recreational, and entertainment purposes.

### SUMMARY

According to the teachings of the present embodiment there is provided a method for learning math including the steps of: (i) providing a template, the template including one or more exercises, each of the exercises including: two or more math expressions, one or more math relationships, and one or more blanks, (ii) providing a solution set of operator-number elements, each one of the operator-number element being a conjugate of a mathematical operation and a number, and (iii) taking a turn by each of one or more players, to try to solve the template using at least one operator-number elements to fill-in the at least one blank, thereby creating a correct mathematical sentence based on the template.

In an optional embodiment, further including: (i) providing a plurality of action tokens, the plurality of action tokens including a plurality of operator-number tokens, the operator-number tokens corresponding to the solution set of operator-number elements and displaying the conjugate of a mathematical operation and a number, (ii) distributing a given number of the action tokens to the one or more players to provide each of the players with a hand of the action tokens, (iii) taking a turn by each of the one or more players, to try to solve the template by playing from the player's hand at least one operator-number token to fill-in the at least one blank, thereby creating a correct mathematical sentence based on the template.

In another optional embodiment, further including providing a plurality of building tokens, each one of the building tokens displaying either: a number, a math relationship, a math operation, or a blank, and the template is provided using the building tokens.

In another optional embodiment, the operator-number tokens further include sign choice tokens displaying a conjugate of: a selection of mathematical operations and a number.

In another optional embodiment, the action tokens further include special action tokens displaying an indication of a special action during the turn of the player. In another optional embodiment, in the step of distributing, the special action tokens are not distributed to the players.

In another optional embodiment, in the step of distributing, the given number of the action tokens is the same as a number of the blanks in the template.

In another optional embodiment, during the turn the player must play the given number of the action tokens to solve the template by filling in the given number of blanks in the template, or discard one of the action tokens from the player's hand.

In another optional embodiment, the action tokens other than the action tokens that were dealt create a draw pile, at the end of the turn, the player discards an action token from the player's hand, and the action tokens that are discarded create a discard pile. In another optional embodiment, during the turn the player picks one action token from either the draw pile or the discard pile, thereby adding the one action token to the player's hand. In another optional embodiment, after the player discards, the turn passes to another player.

In another optional embodiment, the game ends when one of the players plays the given number of the action tokens to solve the template by filling in the given number of blanks in the template, thereby creating a correct mathematical sentence based on the template, thereby the one player wins the game.

In another optional embodiment, the exercise includes two or more blanks.

According to the teachings of the present embodiment there is provided an apparatus for learning math including: (i) a template including one or more exercises, each of the exercises including: two or more math expressions, one or more math relationships, and one or more blanks, (ii) a plurality of action tokens including a plurality of operator-number tokens, the operator-number tokens displaying a conjugate of a mathematical operation and a number, (iii) taking a turn by each of one or more players, to try to solve the template using at least one operator-number elements to fill-in the at least one blank, thereby creating a correct mathematical sentence based on the template.

In another optional embodiment, further including a plurality of building tokens, each one of the building tokens displaying either: a number, a math relationship, a math operation, or a blank, wherein the template is constructed using the building tokens.

In another optional embodiment, the template is configured with all of the one or more blanks of all the one or more exercises accepting any of the plurality of action tokens.

According to the teachings of the present embodiment there is provided a non-transitory computer-readable storage medium having embedded thereon computer-readable code for learning math, the computer-readable code including program code for: (i) providing a template, the template including one or more exercises, each of the exercises including: two or more math expressions, one or more math relationships, and one or more blanks, (ii) providing a solution set of operator-number elements, each one of the operator-number element being a conjugate of a mathematical operation and a number, and (iii) taking a turn by each of one or more players, to try to solve the template using at least one operator-number elements to fill-in the at least one blank, thereby creating a correct mathematical sentence based on the template.

### BRIEF DESCRIPTION OF FIGURES

The embodiment is herein described, by way of example only, with reference to the accompanying drawings, wherein:

FIG. 1, there is shown an exemplary set of tokens (game cards) for implementing a structured playing board for learning math (playing the game).

FIG. 2, there is shown two examples of a template display.

FIG. 3, there is shown an exemplary layout for playing the game with three players.

FIG. 4A, there is shown an exemplary sign choice card.

FIG. 4B, there is shown an examples of special action cards.

FIG. 5, there is shown several math templates.

FIG. 6, there is shown a math template with a given set of operator-numbers.

FIG. 7, there is shown examples where the operator-number tokens given can be greater than, equal to, or less than, the number of the unknowns.

FIG. 8, there is shown alternative versions of numbers.

FIG. 9, there is shown several additional math templates.

FIG. 10, there is shown two math templates with alternative numbers of exercises.

FIG. 11, there is shown a math template with four exercises (equations) and four unknowns.

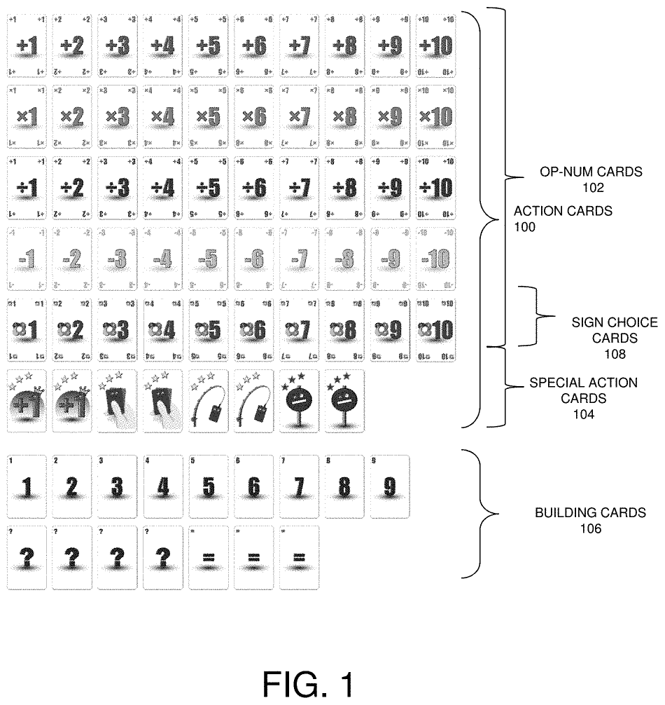

### DETAILED DESCRIPTION—FIGS. 1 to 11

The principles and operation of the apparatus and method according to a present embodiment may be better understood with reference to the drawings and the accompanying description. A present invention is an apparatus and method for learning math.

A structured learning device includes a template of one or more mathematical (math) exercises that are solved using conjugates of mathematical operations and numbers (the conjugate referred to as an “operator-number”, “operation-number”, or “op-num”. The goal is to complete (typically simultaneously and) correctly all of the exercises. A feature of the embodiment is the use of operator-number combinations with a template, using the operator-number to complete blanks in the template and solve one or more exercises.

While common methods of learning math handle mathematical operations and numbers separately and hence the solution to math problems (exercises) is given by numbers, the current embodiment is a novel approach where the solution is given by operator-number conjugates and therefore the exercises does not apply to regular degree of freedom (DOF) analysis.

For example, in a conventional algebraic equation, such as “5x−20=0”, the variable “x” can only be a number (positive or negative) whereas the operation between “5” and “x” is always multiplication. The DOF of the equation is “5x−20=0” is zero (DOF=number of variables—number of equations), which means that there is only one solution to this equation which is “x=4”. In the current implementation, such as in the case of an exercise “5 ?−20=0”, the expression “5 ?” can be completed by the blank (“?”) being an operator-number conjugate, for example, “+4”, “−4”, “×4”, and “÷4”. Therefore, the regular DOF analysis does not apply as one can find multiple solutions to this exercise for example, “+15” and “×4”.

A feature of the embodiment is the use of operator-number combinations not for “local” operations, but with a given mathematical exercise to replace blanks and produce one or more correct mathematical sentences (such as a math equation). This provides a new way to address math problems and opens a new field of math challenges that can improve math skills, enhance learning capacity, and at the same time be enjoyable, as will be shown in this application.

For simplicity and clarity in this description, an exemplary implementation is used of a mathematical card game, where the template and conjugate operator-number tokens are implemented using cards. Some alternative implementations are also described, below. Based on this description, one skilled in the art will be able to implement the current embodiment in a variety of formats and media including, but not limited to, computer screens, (computer) tablets, virtual tokens, paper, and mobile apps.

In the current exemplary implementation, completion of exercises can be with cards, each card including a combination of operator and number (operator-number), or equivalently filling-in a template from a given set or known set of operator-numbers.

In the context of this document, “mathematical templates” are referred to as “templates”. A single template includes one or more mathematical exercises. Each exercise typically includes two or more math expressions, one or more math relationships, and one or more blanks. Each exercise is a math sentence, with a portion of the sentence being blanks. The template is provided to one or more users (students, players), being created according to the players' desired level of complexity, or given to the player, and forming the structured learning device for learning math (in this case, the playing surface for the game).

In the context of this document, a math expression includes numbers, and operations (and optionally variables), but not a mathematical relationship. Math relationships include equals (“=”), greater than (“>”), and less than (“<”). A combination of math expression(s) and math relationship(s) is a math sentence, or in the case of the current embodiment, an exercise.

An exercise (math exercise) refers to a math relation between two or more math expressions. For example, the exercise “4×2=8” presents an equality relation “=” between the expression “4×2” and “8”.

In the context of this document, the term “number” generally refers to integers, but this is not limiting, and also includes fractions, non whole numbers, and other representations of numerical values. In this description, the letter “D” represents any digit, for example in a given family of exercises.

In the context of this document, the term “operations” includes mathematical operations such as “+” (addition), “−” (subtraction), “×” (multiplication), and “÷” (division). Embodiments are not limited to these four operations, and other operations are possible, such as “\hat{ }” (the power operator).

In the context of this document, the term “operation-number”, or simply “operator-number” refers to a conjugate of an operation and a number. For example the operator-number of “+3” refers to the “addition” symbol and number “three” being used together. Typically the operation is displayed to the left of the number, as is standard mathematical practice, but this is not limiting, and the operation and number can be in other relative positions. An operator-number token (card) is a token (card) displaying an operator-number.

In contrast to conventional mathematical learning (games) where the operation and number are handled separately, the innovative operator-number combination results in restrictions and facilitates mathematical exercises that are not obvious from handling an operation and number separately. For example, possible solutions and restrictions based on simultaneously solving multiple linear equations. The combination of templates and operator-number conjugates results in the exercises not being bound by normal multivariable (simultaneous) linear equations degrees of freedom (DOF), instead having DOF dependent on the combination of exercises, within a template, and the given set of operator-numbers. A feature of the current embodiment is the innovative combination of operator-number cards with a template, using the operator-number cards to complete blanks in the template.

In the context of this document, the term “blank”, “blank card”, “unknown”, or “unknown card” generally refers to a part of a template that is not given (a missing token), and needs to be completed by a player to create a correct (or multiple simultaneously correct) mathematical expressions and solve the template. A blank indicates a missing operator-number card in the mathematical expression of the template. In the text of this description, the “?” (question mark) or “_” (underscore) represents a blank. Each blank is typically completed using an operator-number, and preferably, a single blank is completed with a single operator-number.

In the current embodiment of a card game, the exercises, and hence the template can be provided using a set of “building cards”. Building cards typically include numbers, blanks, and math relationships. Typically, a single token (building card) will have a single number, be a single blank, or display a single math relationship. Building cards can optionally include a variety of math functions such as └ . . . ┘ (round down), ┌ . . . ┐ (round up), “\hat{ }” (power), “√” (root), “cos” (cosine), and “sin” (sine). Optionally, building cards can include other symbols, such as math operators, and optionally combinations of the above.

In the context of this document, the term “true math sentence”, or “correct math sentence” is when the math sentence is correct. For example, 7+2=9, 8−3=5, 3×8=24, or 27÷9=3. A template is solved when the blanks of one or more of the exercises (depending on the goals/rules of play) are filled-in with operator-number cards to create a correct math sentence.

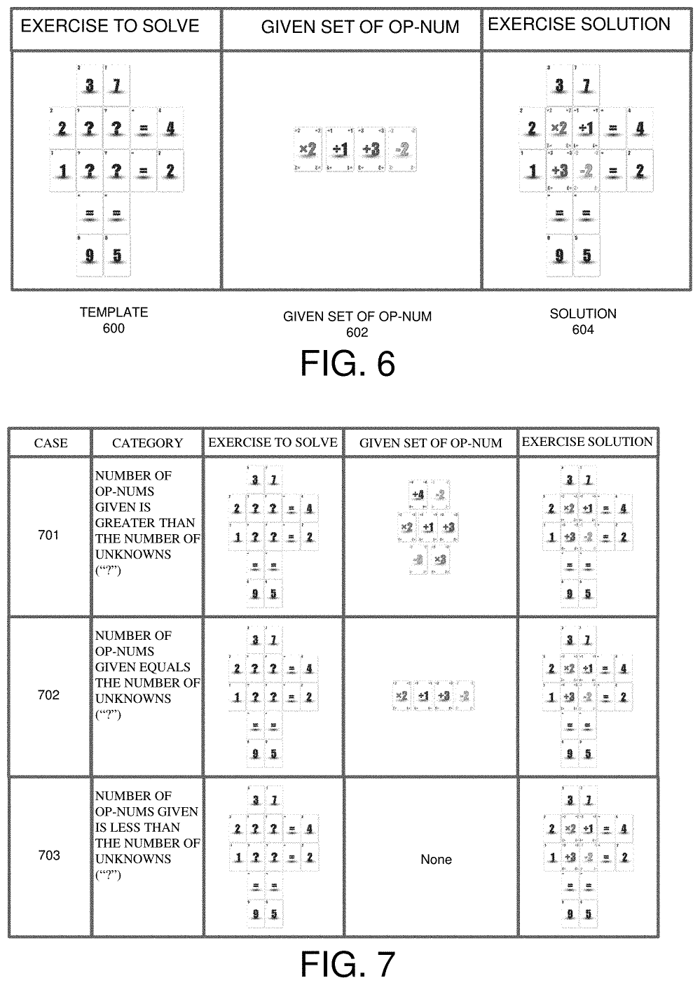

Care should be taken to provide a template that can be solved using the provided action tokens (described below). For example, a specific exercise with a single known solution from the provided action tokens, or a family of exercises with multiple solutions that can be solved from the provided action cards. In the following exemplary implementation, the cards and templates have been designed to provide families of exercises that have a solution, generally multiple solutions. Note that FIG. 6 represent a single solution.

In general, a method for learning math begins by providing a template. The template includes one or more exercises, each of the exercises including two or more math expressions, one or more math relationships, and one or more blanks. A solution set is provided of operator-number elements. Each of the operator-number elements is a conjugate of a mathematical operation and a number. A turn is taken by each of one or more players to try to solve the template using at least one operator-number elements to fill-in the at least one blank, thereby creating a correct mathematical sentence based on the template.

The solution set can be provided as operator-number tokens corresponding to the solution set of operator-number elements and displaying the conjugate of a mathematical operation and a number. Typically, a plurality of operator-number tokens is a subset of a plurality of action tokens. Distributing a given number of the action tokens to the one or more players provides each of the players with a hand of the action tokens. Turns are then taken by each of the (one or more) players to try to solve the template by playing from the player's hand at least one operator-number token to fill-in the at least one blank, thereby creating a correct mathematical sentence based on the template.

An exemplary implementation of the game will first be described using non-limiting examples in order to get a general understanding of the game. Then additional and optional features will be described.

Referring to FIG. 1, there is shown an exemplary game cards (set of tokens) for implementing a structured playing board for learning math (playing the game). The game cards include action cards 100 (action tokens) and building cards 106 (building tokens). Two subsets of action cards are shown, operator-number cards 102 (operator-number tokens) and special action cards 104. A subset of the operator-number cards are the sign choice cards 108. The current figure shows 74 cards: 16 building cards 106 used to build mathematical templates, and 58 action cards 100 used to solve the mathematical templates.

Five sets of ten operator-number cards are shown. Each of the ten cards of each set has one integer from “1” to “10”. Each of four of the sets have one operator “+”, “−”, “×”, and “÷”. One of the five sets is the sign choice cards 108 and the operator (symbol next to the number) indicates that any operation can be chosen (in this case, any operation from the operators being used in the game cards, “+”, “−”, “×”, “÷”). In this description, the “#” (hash mark) will be used to designate selection of an operation. For example, “#4” means that the sign choice operator-number card can be used as “+4”, “−4”, “×4”, or “÷4”.

In other words, a sign choice card displays a conjugate of a “selection of mathematical operations” and a number.

Eight exemplary special action cards 104 are shown, two each of four different special actions, as described below in reference to FIG. 4.

16 building cards 106 are shown including one card each of the integers “1” to “9”, four blanks with a “?” (question mark) symbol, and three “=” (equal signs).

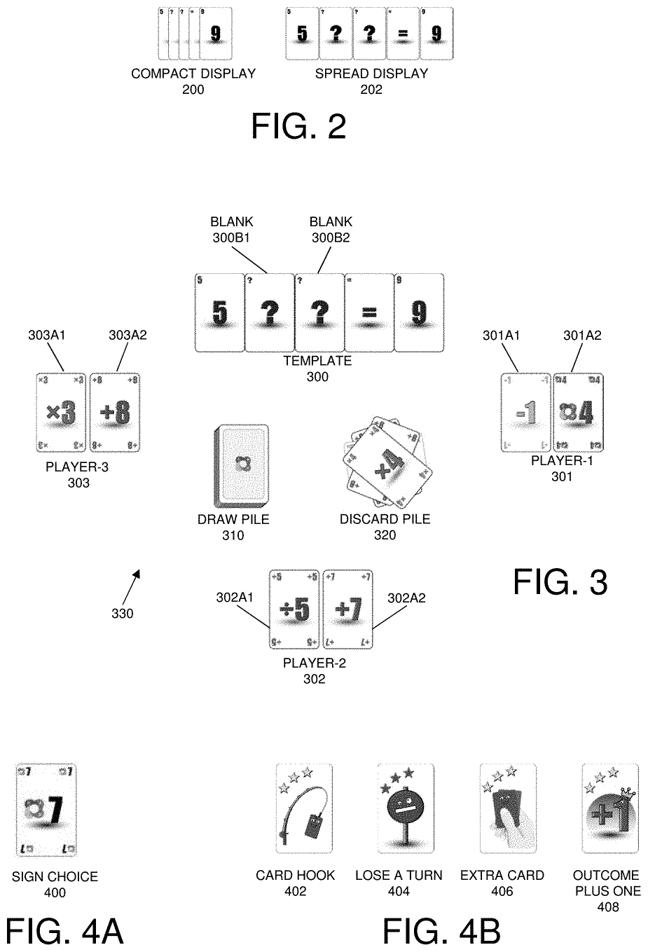

Referring to FIG. 2, there is shown two examples of a template display. The current template has one exercise “5 ? ?=9”. A template can be displayed in a variety of formats, for example a compact display 200 or a spread display 202.

Referring to FIG. 3, there is shown an exemplary layout 330 for playing the game with three players. A method for playing a mathematics game can begin by providing game playing cards. The game playing cards include a plurality of action cards 100, and in this example, a plurality of building cards 106. The action cards 100 include a plurality of operator-number cards 102 (including a plurality of sign choice cards 108), and in this example a plurality of special action cards 104. Each of the operator-number cards 102 displays a conjugate of a mathematical operation and a number, and the special action cards 104 each display an indication of a special action during the turn of the player. The building cards 106 each display a number, an equal sign, or a blank.

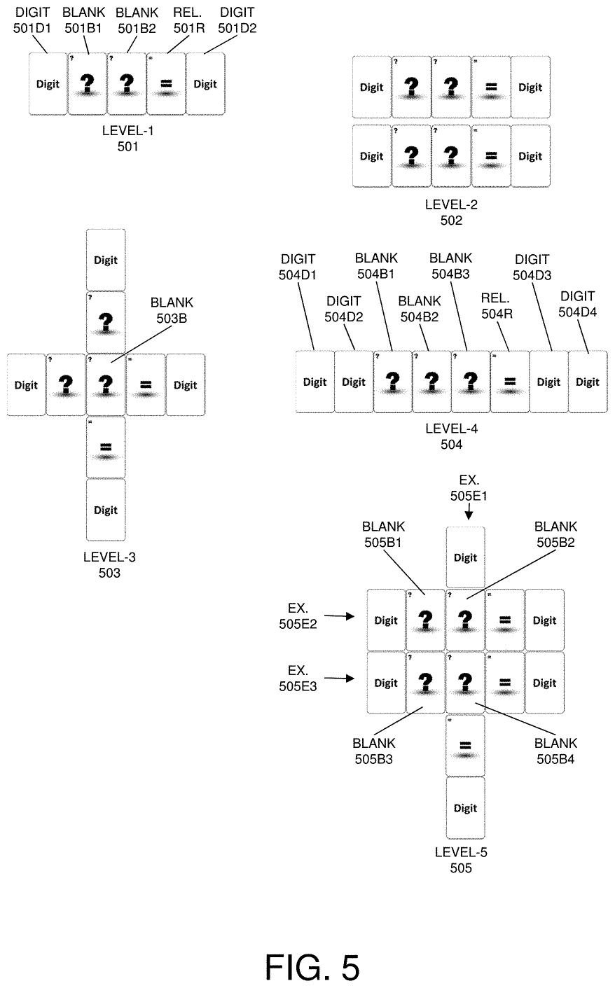

The building cards 106 are used to provide an exercise to be solved, a template 300. In this case, template 300 includes one mathematical exercise “5 ? ?=9”. The template 300 has two blanks (300B1, 300B2) Example templates are described below, in reference to FIG. 5 and elsewhere in this description. The cards of the template 300 are placed face-up so that all players can see the exercise to be solved. The remaining building cards 106 are placed aside as no longer being needed for this round of the game.

The action cards 100 are shuffled and a given number of the action cards 100 are distributed (dealt) to one or more players to provide each of the players with a hand of the action cards 100. In a typical game, the given number of action cards dealt to each player is the same as the number of blanks in the template 300. In this case, there are two blanks (300B1, 300B2), so two action cards 100 are dealt to each player, as can be seen in the current figure. Player-1 301 has two action cards (301A1, 301A2), player-2 302 has two action cards (302A1, 302A2), and player-3 303 has two action cards (303A1, 303A2). During dealing, special action cards 104 are not dealt to the players/not kept by the players. If a player receives a special action card 104, the special action card 104 is returned to the dealer, and another action card 100 is dealt to the player. After dealing is finished, and each player has the required number of action cards in the players' hand, the remaining action cards are shuffled and placed facedown as a draw-pile 310. At the end of each player's turn, the player will discard an action card from the player's hand, and the discarded cards create a discard pile 320.

Play begins, and a turn is taken by each of the players. A player's turn begins with the player picking one action card 100 from either the draw pile 310 or the discard pile 320, thereby adding the one action card to the player's hand. During the player's turn, the player tries to solve the template 300 by playing from the player's hand at least one operator-number card 102 to fill-in at least one blank, thereby creating a correct mathematical sentence based on the template 300. In the current example, the template 300 has two blanks, so a player must be able to play two operator-number cards during the player's turn, to complete the template (solve the exercise with a correct mathematical sentence). Thus, during the turn, the player must either play the given number of the action cards to solve the template by filling in the given number of blanks in the template, or discard one of the action cards from the player's hand. After the player discards, the turn passes to another player.

The game ends when one of the players plays the given number of the action cards to solve the template by filling in the given number of blanks in the template, thereby creating a correct mathematical sentence based on the template, thereby the one player wins the game.

Now is described an exemplary round of play, using the current layout. Player-1 301 goes first. As there is not yet a discard pile 320, player-1 draws one action card 100 from the draw pile 310. Let us assume the card drawn is “+2” (not shown, and designated as 301A3). Player-1 cannot solve the template using the current action cards “4”, “#4”, “+2” (301A1, 301A2, 301A3), and decides to discard sign-choice card “#4” to create the discard pile 320, ending player-1's turn, and passing play to player-2.

Player-2 cannot solve the template 300 using the available cards in hand “÷5”, “+7” (302A1, 302A2) even if the discarded “#4” is picked up, so player-2 draws one action card 100 from the draw pile 310. Let us assume the card is “×2” (not shown, and designated as 302A3). Player-2 cannot solve the template using the current action cards “÷5”, “+7”, “×2” (302A1, 302A2, 302A3), and decides to discard operator-number card “÷5” to the discard pile 320, ending player-2's turn, and passing play to player-3.

Player-3 sees what player-2 did not anticipate: Player-3 can solve the template using the discarded “÷5” card. Player-3 draws the “÷5” card 302A1 from the top of the discard pile, and then plays the “÷5” and “+8” 303A2 respectively to the first blank 300B1 and second blank 300B2. As cards are being used, player-3 can place player-3's action cards on top of the unknown cards (blanks 300B1, 300B2), and a solution is reached when each unknown card is covered. The correct mathematical sentence “5÷5+8=9” is formed based on the template 300, solving the template 300 by filling in the given number of blanks (300B1, 300B2), ending the game with player-3 winning.

Referring to FIG. 4A, there is shown an exemplary sign choice card 400. The design as described above “#7” indicates that the player can choose an operation to use with the number “7”.

In the current example, this card enables the player to choose one of the arithmetic signs: multiplication, division, addition, or subtraction. Therefore, the current sign choice operator-number card can be used as “+7”, “−7”, “×7”, or “÷7”. In cases where the card is used to solve two exercises at once, the chosen sign should be used for both exercises.

Referring to FIG. 4B, there is shown an examples of special action cards 104.

Card hook 402—This card enables the player to use an opponent's (another player's) card instead of taking a card from the discard or draw pile. Preferably, this card can only be used if this action leads to a direct victory. Once a player receives this card, the player keeps this card (no discard at the end of the player's turn) in addition to the cards the player owns. This card can be used only from the player's next turn.

Lose a turn 404—Once a player draws (receives) this card the player loses the current turn. The card should be placed on the discard pile and the turn moves to the next player.

Extra card 406—Once a player draws (receives) this card he should place this card on the discard pile, draw two cards instead and continue his turn regularly so that at the end of the turn the player will have an additional card for the rest of the game.

Outcome plus one 408—This card can be used as an addition to the outcome of one of the equation sides. Once a player receives this card, the player keeps this card in addition to the cards the player owns (in the player's hand) and this card can be used only from the next turn.

Referring to FIG. 5, there is shown several math templates. Each of the templates of the current figure provides a family of exercises that can be solved with multiple solutions using the operator-number cards of the current example. The designation of “levels” for the templates is for convenience, generally a higher level being more difficult to solve than a lower level.

Level-1 501 template is a single exercise “D ? ?=D”, where “D” can be any single digit. The level-1 template 501 includes (left to right) a first digit 501D1, a first blank 501B1, a second blank 501B2, a relationship 501R, and a second digit 501D2. In this case, only the relationship 501R “=” has been specified in the exercise. The two digits (501D1, 501D2) can be chosen as any numbers from the building cards 106. The two blanks (501B1, 501B2) provide the blanks that players try to complete during play.

Level-2 502 template is two exercises, both of the same form “D ? ?=D”. Similar to level-1, the digits can be provided from the building cards 106. Players are dealt four operator-number cards at the beginning of the game, and both exercises need to be completed simultaneously to win the game. Alternatively, players can solve a single one of the two exercises, thus winning that exercise, receiving a point, etc. Play can continue until the other exercise is solved, or another exercise can be provided from the remaining building cards 106 to replace the solved exercise. Other variations are possible.

Level-3 503 template is two exercises, both of the same form “D ? ?=D” (similar to level-1 and level-2), however in this case the two exercises share a common blank 503B. Players are dealt three operator-number cards at the beginning of the game, and both exercises need to be completed simultaneously to win the game. Other variations are possible.

Level-4 504 template is a single exercise “D D ? ? ?=D D” including (left to right) a first digit 504D1, a second digit 504D2, a first blank 504B1, a second blank 504B2, a third blank 504B3, a relationship 504R (“=”), a third digit 504D3, and a fourth digit 504D4. In this case, the first and second digits (504D1, 504D2) combine to form a two-digit number. For example, if the first digit is “8” and the second digit is “1” then the beginning of the exercise is the two-digit number “81”. Similarly with the third and fourth digits (504D3, 504D4).

Level-5 505 template is three exercises (505E1, 5050E2, 505E3), each of the same form “D ? ?=D” (similar to level-1), however in this case a first exercise (505E1) of the three exercises shares each blank (505B2, 505B4) in the first exercise (505E1) with one blank in one of the other two exercises (505B2 in 505E2, and 505B4 in 505E3). Players are dealt four operator-number cards at the beginning of the game, and all three exercises need to be completed simultaneously to win the game. Other variations are possible.

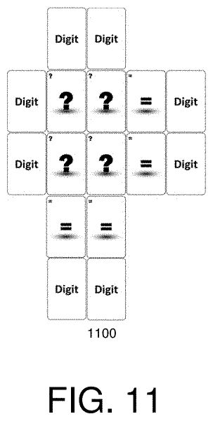

Referring to FIG. 11, there is shown a math template 1100 with four exercises (equations) and four unknowns, each exercise having two blanks, each blank being a blank in one other equation. As such, the digits used for this template should be checked to insure this template can be solved using the available operator-number cards.

Referring to FIG. 6, there is shown math template 600 with a given set of operator-numbers. Similar to template 1100, the template includes four exercises, each of the form “D ? ?=D”. A single player can be given the parameters of the solution set (for example, the operator-number cards 102, and needs to determine which cards are needed and where to place each of the cards to reach the template's solution 604. Alternatively, instead of distributing operator-number cards, the player can be provided a solution set 602. Given set of operator-numbers, a player then needs to determine only the correct placement of the given operator-number tokens to solve the template and reach a solution 604. The current template 600 can be provided to a single player, for example as a daily newspaper offering, book of exercises, or solved using paper and pencil.

Referring to FIG. 7, there is shown examples where the number of the operator-number tokens given can be greater than, equal to, or less than, the number of the unknowns. In the current figure, case 701 the number of operator-numbers given is greater than the number of unknowns, providing a solution set from which the player needs to choose the correct operator-numbers. In case 702 (same as FIG. 6), the number of operator-numbers given equals the number of unknowns. In case 703, the number of operator-numbers given is less than the number of unknowns (so the player must figure out which/additional operator-numbers are needed).

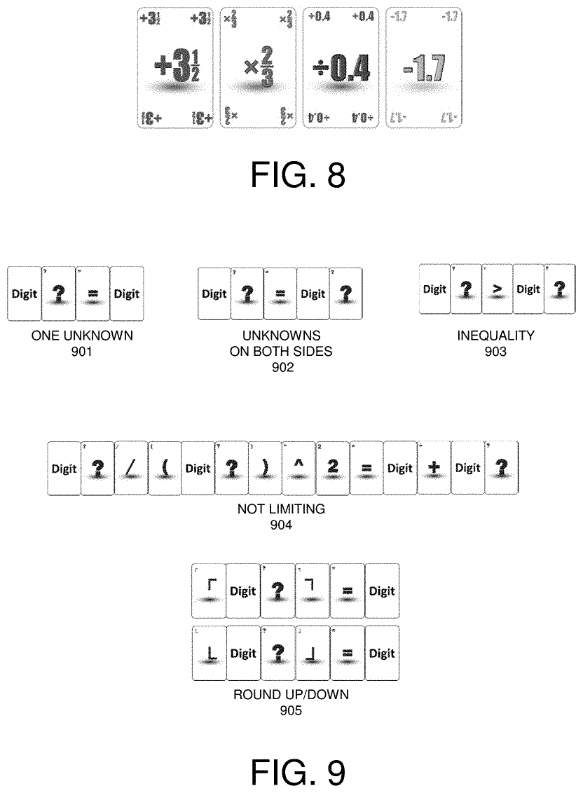

Referring to FIG. 8, there is shown alternative versions of numbers. As described above, in the current description, the term “number” generally refers to integers, but this is not limiting. For example in a template for the digit “D”. In the current figure, operator-number cards of non-integers are shown: a mixed number “+3½”, a fraction “×⅔”, and two decimals “÷0.4” and “−1.7”.

Referring to FIG. 9, there is shown several additional math templates.

Template 901 is a single unknown “D ?=D”.

Template 902 includes unknowns on both sides of the relationship, of the form “D ?=D ?”.

Template 903 has an inequality relationship “D ?>D ?”.

Template 904 is more complex, showing the exercise is not limited to digits, unknowns, and equality sign, of the form “D?/(D?)\hat{ }2=D+D?”.

Template 905 includes two exercises including rounding up and down, of the forms “┌D?┐=D” and “└D┘=D”.

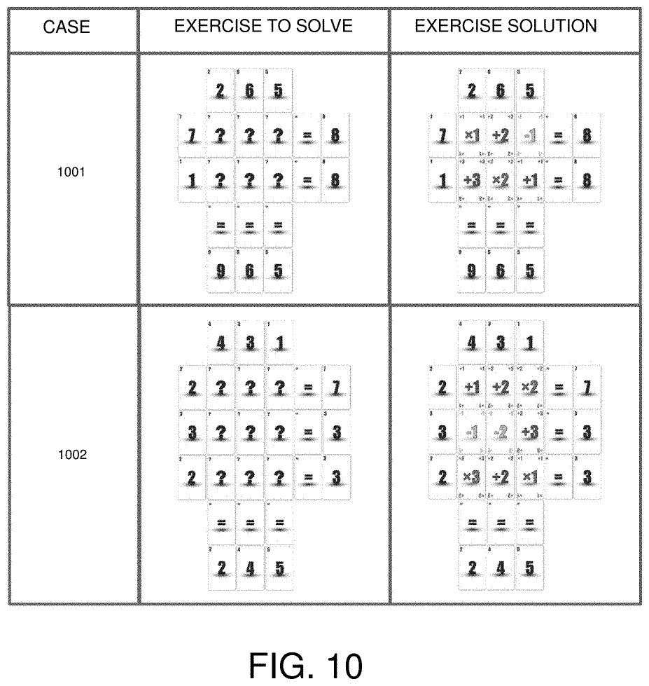

Referring to FIG. 10, there is shown two math templates with alternative numbers of exercises.

Template 1001 has two horizontal exercises each with three blanks and three vertical exercises each with two blanks, each exercise sharing each of all blanks with one other exercise.

Template 1002 has three horizontal and three vertical exercises, each exercise with three blanks.

Typically, order of operations is maintained, that is, multiplication and division come before addition and subtraction, even if the left to right reading of the completed exercise shows addition before multiplication, for example. Alternatively, order of operations does not have to be maintained.

In an optional embodiment, special action cards 104 can be used on the turn the special action cards 104 are drawn, or the next turn.

The players' cards in the layout 330 can be open, allowing other players to see each other's cards, or closed, held so only each player can see that player's cards.

Templates with multiple exercises are not restricted to the given configurations. Additional configurations can include “snake-like” joining, or spirals, where multiple exercises each share one element of the mathematical sentence with one of two different exercises (not shown).

The operator-numbers needed for solving the exercise may need to be acquired (game-like action cards 100), guessed (case 703), provided exactly (case 702), or by other means.

Based on the current description, one skilled in the art will be able to design other templates for learning specific areas of math. For example [(D ? ?)/(D ? ?)]=D ? \hat{ }D.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A method for learning math comprising the steps of:
(a) providing a template, said template including one or more exercises, each of said exercises including:
(i) two or more math expressions,
(ii) one or more math relationships, and
(iii) one or more blanks,
(b) providing a solution set of operator-number elements, each said operator-number element being a conjugate of a mathematical operation and a number, and
(c) taking a turn by each of one or more players, to try to solve said template using at least one operator-number elements to fill-in said at least one blank, thereby creating a correct mathematical sentence based on said template.

2. The method of claim 1 further including:
(a) providing a plurality of action tokens, said plurality of action tokens including a plurality of operator-number tokens, said operator-number tokens corresponding to said solution set of operator-number elements and displaying said conjugate of a mathematical operation and a number,
(b) distributing a given number of said action tokens to the one or more players to provide each of the players with a hand of said action tokens,
(c) taking a turn by each of the one or more players, to try to solve said template by playing from the player's hand at least one operator-number token to fill-in said at least one blank, thereby creating a correct mathematical sentence based on said template.

3. The method of claim 1 further including providing a plurality of building tokens, each one of said building tokens displaying either:
(a) a number,
(b) a math relationship,
(c) a math operation, or
(d) a blank,
and said template is provided using said building tokens.

4. The method of claim 2 wherein said operator-number tokens further include sign choice tokens displaying a conjugate of:
(a) a selection of mathematical operations and
(b) a number.

5. The method of claim 2 wherein said action tokens further include special action tokens displaying an indication of a special action during the turn of the player.

6. The method of claim 5 wherein in said step of distributing, said special action tokens are not distributed to the players.

7. The method of claim 2 wherein in said step of distributing, said given number of said action tokens is the same as a number of said blanks in said template.

8. The method of claim 2 wherein during said turn the player must:
(a) play said given number of said action tokens to solve said template by filling in said given number of blanks in said template, or
(b) discard one of said action tokens from the player's hand.

9. The method of claim 2 wherein:
(a) said action tokens other than said action tokens that were dealt create a draw pile,
(b) at the end of said turn, the player discards an action token from the player's hand, and
(c) said action tokens that are discarded create a discard pile.

10. The method of claim 9 wherein during said turn the player picks one action token from either said draw pile or said discard pile, thereby adding said one action token to the player's hand.

11. The method of claim 9 wherein after the player discards, said turn passes to another player.

12. The method of claim 2 wherein the game ends when one of the player plays said given number of said action tokens to solve said template by filling in said given number of blanks in said template, thereby creating a correct mathematical sentence based on said template, thereby the one player wins the game.

13. The method of claim 1 wherein said exercise includes two or more blanks.

14. An apparatus for learning math comprising:
(a) a template including one or more exercises, each of said exercises including:
(i) two or more math expressions,
(ii) one or more math relationships, and
(iii) one or more blanks,
(b) a plurality of action tokens including a plurality of operator-number tokens, said operator-number tokens displaying a conjugate of a mathematical operation and a number,
(c) taking a turn by each of one or more players, to try to solve said template using at least one operator-number elements to fill-in said at least one blank, thereby creating a correct mathematical sentence based on said template.

15. The apparatus of claim 14 further including a plurality of building tokens, each one of said building tokens displaying either:
(a) a number,
(b) a math relationship,
(c) a math operation, or
(d) a blank,
wherein said template is constructed using said building tokens.

16. The apparatus of claim 14 wherein said template is configured with all of said one or more blanks of all said one or more exercises accepting any of said plurality of action tokens.

17. A non-transitory computer-readable storage medium having embedded thereon computer-readable code for learning math, the computer-readable code comprising program code for:
(a) providing a template, said template including one or more exercises, each of said exercises including:
(i) two or more math expressions,
(ii) one or more math relationships, and
(iii) one or more blanks,
(b) providing a solution set of operator-number elements, each said operator-number element being a conjugate of a mathematical operation and a number, and
(c) taking a turn by each of one or more players, to try to solve said template using at least one operator-number elements to fill-in said at least one blank, thereby creating a correct mathematical sentence based on said template.
